(19) United States
(12) Patent Application Publication
(10) Pub. No.: US 2005/0209833 A1
(43) Pub. Date: Sep. 22, 2005

(54) Methods and systems for estimating usage of components for different transaction types

(76) Inventors: Thomas Patrick Bishop, Austin, TX (US); Michael A. Martin, Round Rock, TX (US); Timothy L. Smith, Austin, TX (US); Robert F. Tulloh, Austin, TX (US); David J. Wilson, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/755,790

(22) Filed: Jan. 12, 2004

(51) Int. Cl. G06F 17/10

(52) U.S. Cl. 703/2

(57) ABSTRACT

Methods and systems of estimating usage of components within an application environment can use statistical, rather than deterministic methods that may be too intrusive or disturb a network used by the application environment. Different transaction types may have estimated usage of components within the application environment and its corresponding confidence level (that the transaction type uses that specific component) calculated and presented to a user. Asynchronous data and data routinely generated by a component may be used. The workload and utilization data may be conditioned before determining the estimated usage to smooth and filter data and determine accuracy of the correlations.

### FIELD OF THE INVENTION

The invention relates in general to methods and systems for estimating usage of components in a network, and more particularly, to methods and systems for estimating usage of components used by one or more transaction types running on a network.

### DESCRIPTION OF THE RELATED ART

Theoretically, usage of components by an application can be obtained using a deterministic approach. In one example, a Unix system records a user identifier in a process table. Every time the central processing unit (CPU) is run on behalf of an operator, corresponding information is recorded in the process table. An operator can determine over the last hour which users used a server computer what percent of CPU utilization by using the process table.

While a deterministic approach is more likely to yield the actual usage, a deterministic approach may not be used in some situations. Many deterministic methods are intrusive. Gates may need to be placed at the beginning and end of every resource used. In many places within a computer system, the information may not be available or recorded.

Also, the information may be inaccurate. A web server may be coupled to a database, and many different applications with different operators may be operating within the web server's computer environment. From the database's perspective, it just sees requests from the web server. The requests do not come with a tag that indicates that a particular work request is received by the database on behalf of a specific operator or application. Therefore, in general, determining what percentage of the database capacity is being used by any specific operator or application is unknown.

Servers have been examined for determining quality of service guarantees for the servers only. Workload data and utilization data can be collected and processes. The method can be used to determine what workloads and utilization measurements are moving together. This information can be used to provide a guarantee that the server will be able to respond within a certain amount of time when a specific type of transaction is processed on the server.

Trying to determine the quality of service for an application is substantially more complicated that just examining what is going on within a single server. An application may use many different hardware or software components. Those different components have different vendors and different versions of the same type of components may be used within a single application environment. Further, the application environment is typically dynamic as components can be turned on and off, removed, added, replaced, updated, and the like. The methodology used for a single server, by itself, does not work well in the real world of distributed computing with complex relationships due to many different components, vendors, and versions.

### SUMMARY

Methods and systems of estimating usage of components within an application environment can be use statistical, rather than deterministic methods that may be too intrusive or disturb a network used by the application environment. Different transaction types may have estimated usages of components within the application environment and their corresponding confidence level (that a specific transaction type uses a specific component) calculated and presented to a user. Asynchronous data and data routinely generated by a component may be used. The workload and utilization data may be conditioned before determining the estimated usage to smooth and filter data and determine accuracy of the correlations.

In one set of embodiments, a method of estimating usage of a component within an application environment can comprise conditioning data regarding a workload and utilization of a component. The method can also comprise determining an estimated usage of the component for a transaction type. The estimated usage may be performed during or after conditioning the data.

In still another set of embodiments, a method of estimating usage of a component within an application environment can comprise accessing data regarding a workload and utilization of the component. The method can also comprise determining an estimated usage of the component for a transaction type. The estimated usage may be determined using a mechanism that is designed to work with a collinear relationship, such as ridge regression.

In yet another set of embodiments, a method of estimating usage of a component within an application environment can comprise separating data regarding a workload and utilization of the component into sub-sets. For each of the sub-sets, the method can also comprise determining an estimated usage of the component for a transaction type and performing a significance test using the estimated usages for the sub-sets.

In further sets of embodiments, data processing system readable media can comprise code that includes instructions for carrying out the methods and may be used on the systems.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a hardware configuration of a system for managing an application that runs on a network.

FIG. 2 includes an illustration of a hardware configuration of the application management appliance in FIG. 1.

FIG. 3 includes an illustration of hardware configuration of one of the management blades in FIG. 2.

FIG. 4 includes an illustration of a process flow diagram for a method of determining usage of components for a transaction type that runs on a network in accordance with an embodiment of the present invention.

FIG. 5 includes an illustration of a more detailed process flow diagram for a portion of the process in FIG. 4.

FIG. 6 includes an illustration of a view for setting a confidence level and score cutoff display.

FIGS. 7 and 8 include illustrations of views listing components used by an application.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Methods and systems of estimating usage of components within an application environment can use statistical, rather than deterministic methods that may be too intrusive or disturb a network used by the application environment. Different transaction types may have estimated usages of components within the application environment and their corresponding confidence level (that a specific transaction type uses a specific component) calculated and presented to a user. Asynchronous data and data routinely generated by a component may be used. The workload and utilization data may be conditioned before determining the estimated usage to smooth and filter data and determine accuracy of the correlations.

A few terms are defined or clarified to aid in understanding the descriptions that follow. The term “application environment” is intended to mean any and all hardware, software, and firmware used by an application. The hardware can include servers and other computers, data storage and other memories, switches and routers, the like. The software used may include operating systems.

The term “asynchronous” is intended to mean that actual data are being taken at different points in time, at different rates (readings/unit time), or both.

The term “averaged” when referring to a value (e.g., estimated usage) is intended to mean any method of determining a representative value corresponding to a set of values, wherein the representative value is between the highest and lowest values in the set. Examples of averaged values include an average (sum of values divided by the number of values), a median, a geometric mean, a value corresponding to a quartile, and the like.

The term “component” is intended to mean any part of a system in which an application may be running. Components may be hardware, software, firmware, or virtual components. Many levels of abstraction are possible. For example, a server may be a component of a system, a CPU may be a component of the server, a register may be a component of the CPU, etc. For the purposes of this specification, component and resource are used interchangeably.

The term “usage” is intended to mean the amount of utilization of a component during the execution of a transaction. Compare with utilization, which is not specifically measured within respect to a transaction.

The term “utilization” is intended to mean how much capacity of a component was used or rate at which a component was operating during any point or period of time.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done, merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting, exemplary hardware architecture for using embodiments of the present invention is described. After reading this specification, skilled artisans will appreciate that many other hardware architectures can be used in carrying out embodiments described herein and to list every one would be nearly impossible.

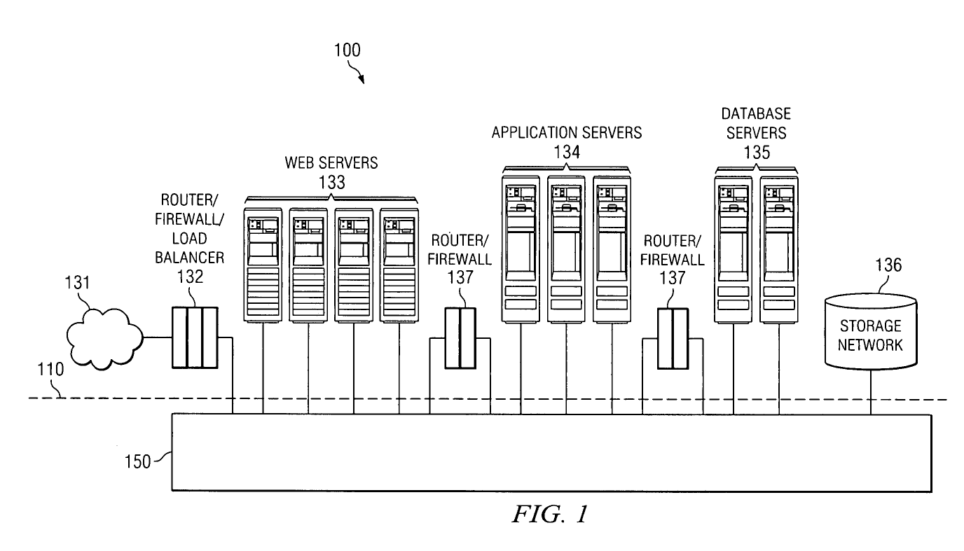

FIG. 1 includes a hardware diagram of a system 100. The system 100 includes a network 110, which is the portion above the dashed line in FIG. 1. The network 110 includes the Internet 131 or other network connection, which is coupled to a router/firewall/load balancer 132. The network further includes Web servers 133, application servers 134, and database servers 135. Other computers may be part of the network 110 but are not illustrated in FIG. 1. The network 110 also includes storage network 136 and router/firewalls 137. Although not shown, other additional components may be used in place of or in addition to those components previously described. Each of the components 132-137 is bi-directionally coupled in parallel to an appliance (apparatus) 150. In the case of router/firewalls 137, both the inputs and outputs from such router/firewalls are connected to the appliance 150. Substantially all the traffic for components 132-137 in network 110 is routed through the appliance 150. Software agents may or may not be present on each of components 132-137. The software agents can allow the appliance 150 to monitor and control at least a part of any one or more of components 132-137. Note that in other embodiments, software agents may not be required in order for the appliance 150 to monitor and control the components.

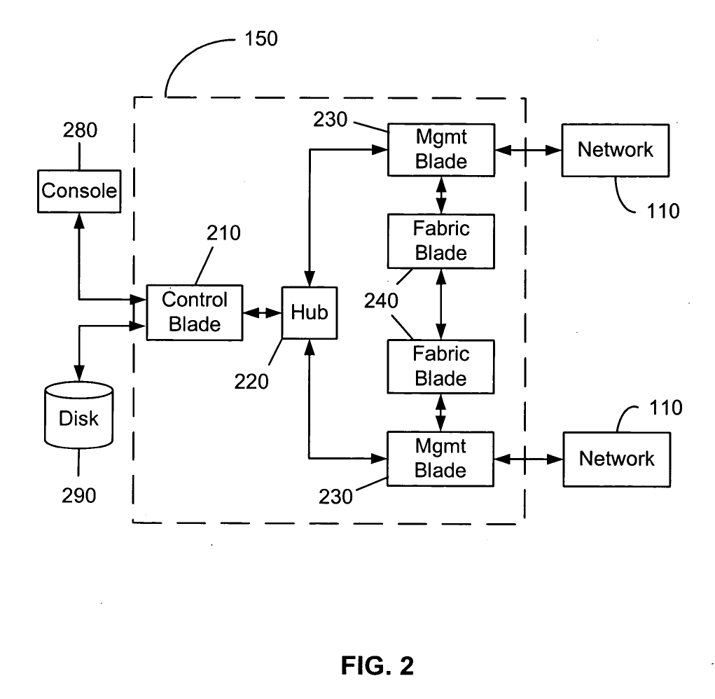

FIG. 2 includes a hardware depiction of the appliance 150 and how it is connected to other components of the system. The console 280 and disk 290 are bi-directionally coupled to a control blade 210 within the appliance 150. The console 280 can allow an operator to communicate with the appliance 150. Disk 290 may include data collected from or used by the appliance 150. The appliance 150 includes a control blade 210, a hub 220, management blades 230, and fabric blades 240. The control blade 210 is bi-directionally coupled to a hub 220. The hub 220 is bi-directionally coupled to each management blade 230 within the appliance 150. Each management blade 230 is bi-directionally coupled to the network 110 and fabric blades 240. Two or more of the fabric blades 240 may be bi-directionally coupled to one another.

Although not shown, other connections and additional memory may be coupled to each of the components within appliance 150. Further, nearly any number of management blades 230 may be present. For example, the appliance 150 may include one or four management blades 230. When two or more management blades 230 are present, they may be connected to different parts of the network 110. Similarly, any number of fabric blades 240 may be present and under the control of the management blades 230. In still another embodiment, the control blade 210 and hub 220 may be located outside the appliance 150, and nearly any number of appliances 150 may be bi-directionally coupled to the hub 220 and under the control of control blade 210.

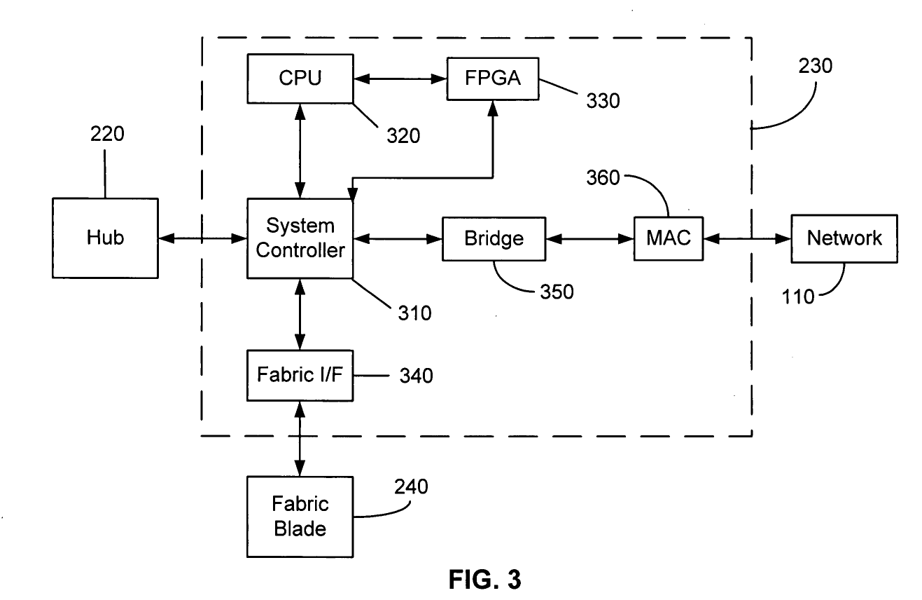

FIG. 3 includes an illustration of one of the management blades 230, which includes a system controller 310 bi-directionally coupled to the hub 220, central processing unit (“CPU”) 320, field programmable gate array (“FPGA”) 330, bridge 350, and fabric interface (“I/F”) 340, which in one embodiment includes a bridge. The system controller 310 is bi-directionally coupled to the hub 220. The CPU 320 and FPGA 330 are bi-directionally coupled to each other. The bridge 350 is bi-directionally coupled to a media access control (“MAC”) 360, which is bi-directionally coupled to the network 110. The fabric I/F 340 is bi-directionally coupled to the fabric blade 240.

More than one of some or all components may be present within the management blade 230. For example, a plurality of bridges substantially identical to bridge 350 may be used and bi-directionally coupled to the system controller 310, and a plurality of MACs substantially identical to MAC 360 may be used and bi-directionally coupled to the bridge(s) 350. Again, other connections and memories (not shown) may be coupled to any of the components within the management blade 230. For example, content addressable memory, static random access memory, cache, first-in-first-out (“FIFO”) or other memories or any combination thereof may be bi-directionally coupled to FPGA 330.

The appliance 150 is an example of a data processing system. Memories within the appliance 150 or accessible by the appliance 150 can include media that can be read by system controller 310, CPU 320, or both. Therefore, each of those types of memories includes a data processing system readable medium.

Portions of the methods described herein may be implemented in suitable software code that may reside within or accessibly to the appliance 150. The instructions in an embodiment of the present invention may be contained on a data storage device, such as a hard disk, a DASD array, magnetic tape, floppy diskette, optical storage device, or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another appliance substantially identical to appliance 150 or by a computer, such as any one or more illustrated in FIG. 1. Additionally, a computer program or its software components with such code may be embodied in more than one data processing system readable medium in more than one computer.

Communications between or within any of the components 132-137 and appliance 150 in FIGS. 1-3 may be accomplished using electronic, optical, radio-frequency, or other signals. For example, when an operator is at the console 280, the console 280 may convert the signals to a human understandable form when sending a communication to the operator and may convert input from a human to appropriate electronic, optical, radio-frequency, or other signals to be used by or within and one or more of the components 123-137 and appliance 150.

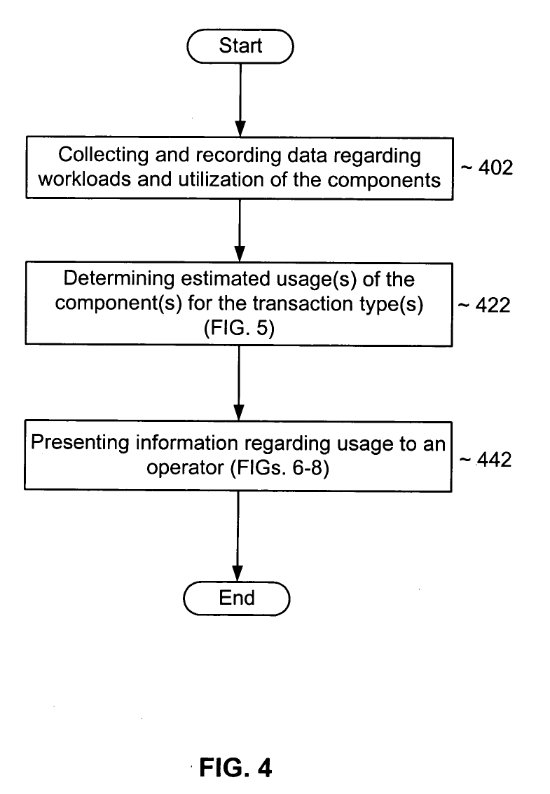

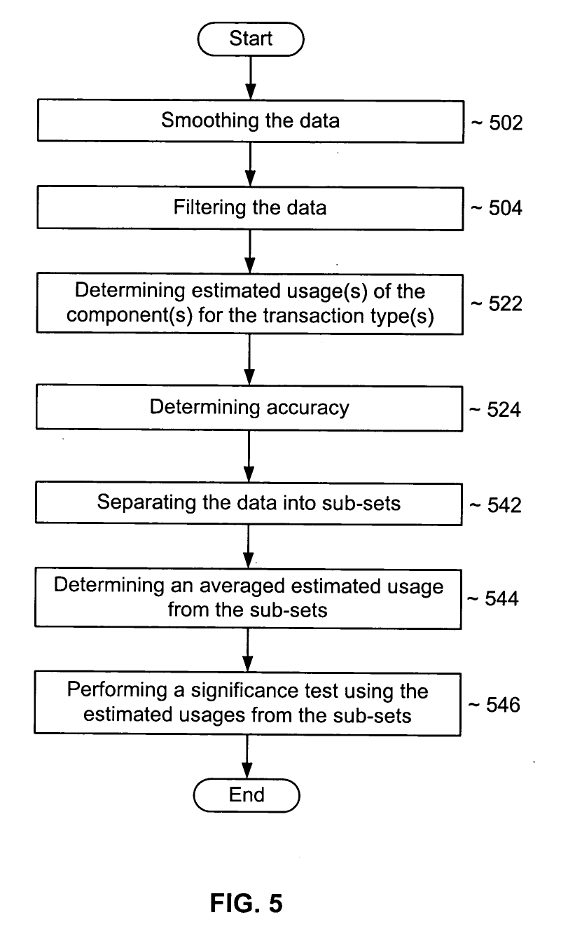

Attention is now directed to the software architecture of the software in accordance with one embodiment of the present invention. The software architecture is illustrated in FIGS. 4 and 5 and is directed towards determining estimated usage(s) of component(s) for transaction type(s).

An application can include one or more transactions. For an application used at a web site, the types of transactions may include generating a page requested, placing an order, activating a help screen, etc. The application itself may be considered a transaction type (e.g., inventory management). For other applications, whether or not used with a web site, the types of transactions may be the same or different to those used at a web site.

The method can include collecting and recording data regarding workloads and utilization of the components (block 402 in FIG. 4). Workload data may include measurements for a series of uniform time intervals (e.g., average number of requests/second, average Kb of workload/second, etc.). Utilization data may include measurements during the same time intervals (e.g., CPU utilization (%), memory utilization (%), calls/second, files/second). Note that the utilization data may not be specific to a workload.

Network 110 includes many different components with different mechanisms for collecting data. The data for each of the components may be collected at different times, at different rates, or both. Because the network 110 has many different components (software, hardware, firmware, etc.), the likelihood that all data from all components will be collected at the same time and rate is substantially zero. Therefore, the data collected is asynchronous. The collected data may be sent to the appliance 150 and recorded in memory, such as disk 290.

The components in the network 110 may be capable of providing the data upon request. In other words, the component may normally collect data. For example, a CPU may monitor how much CPU utilization is being used by an operator. If requested, the CPU may be able to determine how much of its utilization was being used by the operator at any point or period of time. If the data is not provided upon request, a software agent may be installed on the component and used to send data available at the component to the appliance 150. In one embodiment, only data normally available at the component is collected and sent by the software agent.

In another embodiment, the software agent may be used generate data at the component or give instructions to the component to generate data, where the data is not otherwise available in the absence of the software agent. Generating data at that component that is not otherwise normally collected by the component can disturb the operation of component. However, such a software agent could still be used within the scope of the present invention.

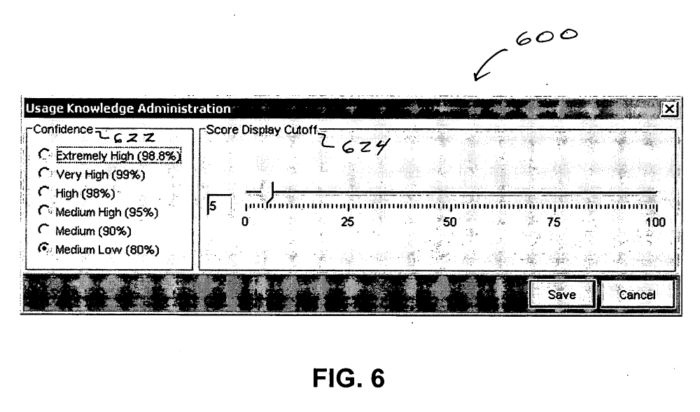

The method can also comprise determining estimated usage(s) of the component(s) for the transaction type(s) (block 422 in FIG. 4). The usage determination may be performed for any number of transaction types or components. The determination is described in more detail with respect to FIG. 5. The method can further comprise presenting information regarding usage to an operator (block 442). Views of the information are described in more detail with respect to FIGS. 6-8.

FIG. 5 includes a process flow diagram that can be used in determining estimated usage and confidence levels for the estimated usage. The method can comprise conditioning the data. Conditioning can include any one or more of smoothing the data (block 502), filtering the data (block 504), and determining accuracy (block 524). Smoothing and filtering is typically performed before determining estimated usage.

Smoothing can be used to address two different situations. Usage determination should be performed using data at a precise point in time or for a specific time period. As pointed out previously, the data is asynchronous. While data on one component is being collected, the last reading from another component may have been collected milliseconds ago, and the last reading from another component may have been collected seconds, minutes, hours, or days earlier.

In one situation, smoothing may determine a value for the data that is more reflective of the time of other readings. Data at time (“t”)=1.0 is to be used. However, data on utilization of a component may have been taken at t=0.5 and t=1.5. Data at t=1.0 for the component may be an averaged value using the data at t=0.5 and t=1.0. Many other types of interpolation may be used and potentially includes additional historic values (t=−0.5, t=−1.5, etc.) to achieve the averaged value of the data at t=1.0. Examples can include computing a rolling average, geometric mean, median, or the like.

If the data is being taken real time (currently t=1.0, and t=1.5 is in the future), the last value(s) and change(s) between those values (i.e., derivative(s)) can be used to extrapolate the value in the future.

The other situation with smoothing addresses potentially relatively older data and whether it should be used. For example, the CPU utilization by an operator may change many times during a second. If the CPU utilization data is more than a second old, it may be deemed to be too old for use with the method, and therefore, not be used. Transmission rates of large files may not fluctuate significantly during a second, and therefore, would be used. After reading the specification, skilled artisans will appreciate that different components may having changes in utilization that occur at slower or faster rates compared to other components. Skilled artisans may determine the time for each component or type of component at which point such data has become untrustworthy or stale.

Filtering the data (block 504) is to remove data that does not accurately reflect normal, “near-zero” operations. A stationary car that is idling may appear to a casual observer 100 meters away that the car is doing nothing, when in reality, the engine is running. Similarly, components within the system 100 may appear not to be in use when they are actually idling. Data from component at or near idling conditions may not be useful or result in poor usage estimations. Data from these “near-zero” operations may be filtered out and not used.

Filtering can also remove data from operations that are abnormal. For example, power to the system 100 may have been disrupted causing ⅔ of the components within system 100 to be involved in rebooting, restarting, or recovery operations after power is restored. While the system 100 may still operate, non-essential operations may be suspended or performed at a substantially slower rate. Therefore, utilization data for workloads during and soon after the power outage may not be reflective of how the system 100 normally operates. Other conditions of the system 100 may not be explained, appear unusual, etc., and data during those conditions should not be used.

Filtering may be used for other reasons. After reading this specification, skilled artisans will appreciate that filters can be tailored for the system 100 or any part thereof as a skilled artisan deems appropriate.

The method can include determining estimated usage(s) of the component(s) for the transaction type(s) (block 522). To simplify understanding, one estimated usage will be described for one transaction type and one component. Skilled artisans appreciate that the concepts can be extended to other components used by the transaction type and performed for other transaction types. The estimate usage may be in units of CPU % per specific transaction type request, CPU % per Kb of specific transaction type activity, etc.

Regression can be used to determine the estimated usage. If the relationship between the transaction type activity and utilization of the component is linear, additional transactions of the same transaction type should cause a linear increase in the utilization of the component. In one embodiment, an ordinary least squares regression methodology is used to estimate usage. If the correlation between transaction type and utilization of the component is strong, the component may be designated as being used (as will be described later), and if the correlation between transaction type and utilization of the component is weak, the component may be designated as being unused. The designation of used and unused is described later. In an alternative embodiment, multiple linear regression can be used.

Collinearities can result when one parameter tracks or follows another parameter. The usage estimate may be determined using a mechanism that is designed to work with a collinear relationship. Ridge regression is a conventional type of regression that works well with collinearities.

The method can further include determining accuracy (block 524). The accuracy determination may be performed during or after the usage estimation. The estimated usage indicate that transactions of a specific transaction type tend to cause n kb/s to be read from the disk, wherein n is a numerical value and the disk is an example of the component. Accuracy compares actual and estimated usage of the component. The accuracy can be calculated using an R² statistic. The correlation between the predicted and the actual usage is squared. A higher value means higher accuracy. An operator may determine at what level the accuracy become high enough that he or she would conclude the correlation is significant.

The next portion of the method may be called component usage determination and is illustrated by blocks 542-546 in FIG. 5. By performing the usage determination over a series of time periods, an averaged usage rate for the specific transaction type may be determined at a corresponding confidence level.

The method may include separating the data into sub-sets (block 542). Data can be collected over a time span. The data may be separated into sub-sets based different time periods within the time span. Nearly any number of sub-sets can be used. Three to five sub-sets are sufficient for many embodiments. For example, data over the last five hours may be divided into five sequential one hour time periods. Note that other time spans, different sizes of time periods may be used, or both may be used for separating the data into sub-sets. The method can further include determining an averaged estimated usage from the sub-sets (block 544). The averaged estimated usage can be calculated using an average, a geometric mean, a median, or the like. The method can still further include performing a significance test using the estimated usages from the sub-sets (block 546). A t-test is an example of the significance test. In an alternative embodiment, another conventional significance test may be used. At this point, an averaged estimated usage of a component for a specific transaction type and its corresponding confidence level have been determined.

The method can continue with presenting information regarding usage to an operation (block 442), which is described with respect to FIGS. 6-8. FIG. 6 includes an illustration of a usage knowledge administrator view 600. An operator may select a confidence level 622 and a score display cutoff 624. Only those components meeting the confidence level 622 and score display cutoff 624 limits will be presented. In another embodiment, components meeting the confidence level 622 or score display cutoff 624 limit will be presented. In FIG. 6, the confidence level 622 is set at medium low (80%) and the score display cutoff 624 is set at 5.

The higher the confidence level, the greater likelihood that a specific transaction type actually uses a component. A medium low (80%) confidence level may be useful, although it may be less likely to exclude components are actually used by the transaction type compared to when a higher confidence level is used. Higher confidence levels may be used to only present those components with only the strongest associations to the transactions types. In other embodiments, lower or higher confidence levels may be used.

The score can represent a worst-case or near worst-case measure of accuracy. Note that the actual accuracy may be higher than the score. In general, higher scores are desired, but a low score does not necessary indicate poor accuracy. The score display cutoff 624 can be used to determine the minimum scoring level needed to display a component. At a score of 0, all components with a confidence level of at least 80% would be shown.

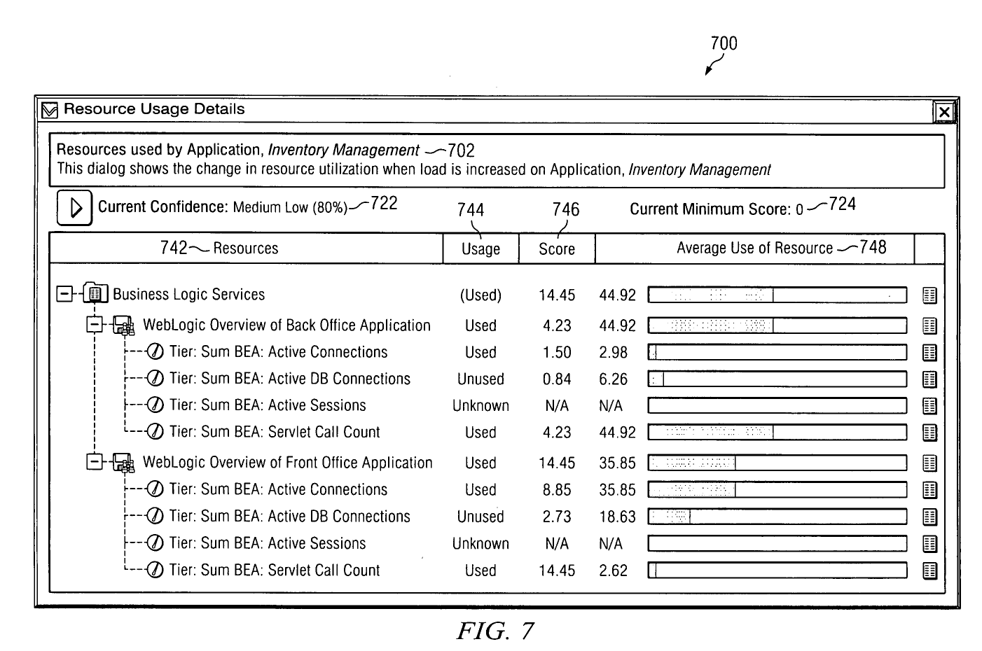

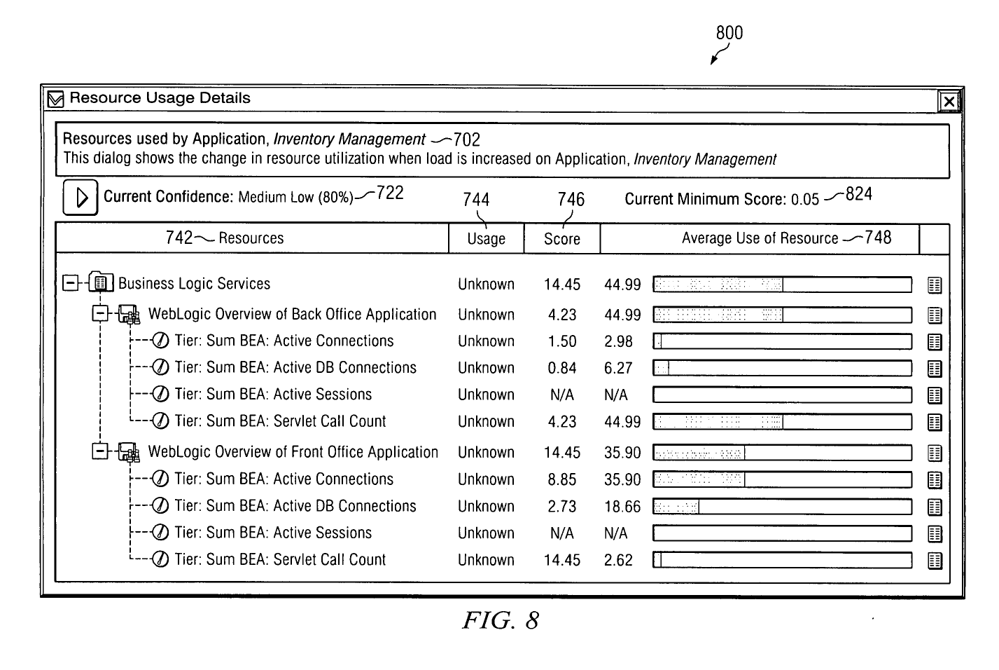

FIGS. 7 and 8 include views 700 and 800, respectively, that may be presented to an operator. In view 700 of FIG. 7, the transaction type 702 is called “Inventory Management.” Current confidence 722 is medium low (80%) and current minimum score 724 is 0. The numbers for the current confidence 722 and current minimum score 724 can be set using the data input screen in view 600 of FIG. 6.

View 700 further includes information regarding the resources 742, usage 744, score 746, and average use of the resource 748. Resources 742 are examples of components, and the average use of the resource corresponds to the averaged estimated usage described above. In view 700, “Business Logic Services” are seen. The Business Logic Services include WebLogic™ Overview of Back Office Applications and WebLogic™ Overview of Front Office Applications. Other components (hardware, software, firmware, etc.) do not appear in view 700 but would be present if the view 700 were scrolled up or down.

The usage 744 may have values of used, unused, or unknown. The score 746 may have a numerical value, and the average use of the resource 748 may have a numerical value and a graphical representation.

View 800 in FIG. 8 is very similar. The current minimum score 824 is 0.05 instead of 0 (in view 700). Also, all usages 744 are unknown. All other information in view 800 in FIG. 8 is substantially identical to view 700. Although not shown, at least one component that would otherwise be presented with view 700 (when scrolling up or down), may not be presented with view 800.

If the score display cutoff 624 (in FIG. 6) would be increased to 5, some items seen in FIGS. 7 and 8 would not be present. For example, WebLogic™ Overview of Back Office Applications and all components within it would not be presented. Only “Tier: Sum BEA: Active Connections” and “Tier: Sum BEA: Servlet Call Count,” would be presented under WebLogic™ Overview of Front Office Applications.

After reading this specification, skilled artisans will appreciate that the views in FIGS. 6-8 can be modified to include more information, have less information, or present the information in a different format. The views are merely parts of non-limiting exemplary embodiments.

Note that not all of the activities described above are required, that an element within a specific activity may not be required, and that further activities may be performed in addition to those illustrated. Still further, the order in which each of the activities are listed are not necessarily the order in which they are performed. After reading this specification, skilled artisans will be capable of determining what activities can be used for their specific needs.

Embodiments described above may have benefits not seen with conventional methods. The method can be implemented so that it appears nearly transparent to network 110. Although traffic is routed through appliance 150, it gathers the data it needs and routes the information to the next component quickly. The methods use statistical methods to provide estimated usages without using intrusive deterministic techniques. The method can be used during normal transactional or other application activity on the network 110. The network 110 does need to be shut down to collect experimental data. Therefore, no down time or reduced capacity may occur when using the method. Still, if desired an operator may run designed experiments to potential reduce the need for conditioning data or performing accuracy or significance tests.

Along similar lines, the method can be used to determine estimated usages of components based on asynchronous data. The asynchronous data can occur due to the presence of many different types of components, vendors, versions, etc. that collect data at different times, rates, or both. Forcing synchronization by mandating components to take readings at specified times and frequencies is not required. Such forced synchronization can unnecessarily disturb the network. In one embodiment, by using data that a component normally gathers at whatever time or rate it would anyway, data collection can occur without any significant disruption of the network. However, forced synchronization can work with the method described herein and is within the scope of the present invention.

Conditioning the data can be performed so that the data appear synchronized with respect to the system and filters out data obtained during idling, abnormal conditions, or both. Usage estimations can be more accurately determined when such conditioning is performed.

Many of the calculations can be made using conventional statistical methods. In one embodiment, estimated usage may be determined using regression, accuracy can be calculated using an R² statistic, the averaged estimated usage can be an average value, and the significance test may be a t-test. New statistical methods are not needed.

The ability to present usage of components based on a minimum confidence level, score, or both allows an operator to quickly see and understand which components are used for a specific transaction type. The process can be repeated for nearly any other transaction type. Further, the operator may have the ability to define how granular the components or transaction types he or she desires. Components may stop at a high level (e.g., a server), go down to the CPU (within a server, down to the register level (within the CPU), or even down to the transistor level (within the register), if such information is available. Likewise transaction types may stop at the application level, go down to a class level, an object within the class, or go down to a line of source code, if such information is available.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A method of estimating usage of a component within an application environment, wherein the method comprises:
conditioning data regarding workload and utilization of a component; and
determining an estimated usage of the component for a transaction type, wherein determining the estimated usage is performed during or after conditioning the data.

2. The method of claim 1, further comprising:
separating the data into sub-sets;
determining an averaged estimated usage from the estimated usages for the sub-sets; and
performing a significance test using the estimated usages for the sub-sets,
wherein determining an estimated usage comprises determining an estimated usage for each of the sub-sets.

3. The method of claim 1, wherein conditioning includes one or more of:
smoothing the data;
filtering the data; and
determining an accuracy for the estimated usage.

4. The method of claim 1, wherein the data is asynchronous.

5. The method of claim 1, wherein determining the estimated usage is performed using regression.

6. The method of claim 1, wherein:
the method further comprises collecting the data asynchronously;
conditioning comprises:
smoothing the data before determining the estimated usage; and
filtering the data before determining the estimated usage;
determining the estimated usage is performed using regression; and
the method further comprises determining an accuracy for the estimated usage.

7. The method of claim 6, further comprising:
separating the data into sub-sets;
determining an averaged estimated usage from the estimated usages for the sub-sets; and
performing a significance test using the estimated usages for the sub-sets,
wherein determining an estimated usage comprises determining an estimated usage for each of the sub-sets.

8. An apparatus operable for carrying out the method of claim 1.

9. A method of estimating usage of a component within an application environment, wherein the method comprises:
accessing data regarding workload and utilization of the component; and
determining an estimated usage of the component for a transaction type, wherein determining is performed using a mechanism that is designed to work with a collinear relationship.

10. The method of claim 9, further comprising conditioning the data before determining the estimated usage.

11. The method of claim 10, wherein conditioning includes one or more of:
smoothing the data;
filtering the data; and
determining an accuracy for the estimated usage.

12. The method of claim 9, further comprising:
separating the data into sub-sets;
determining an averaged estimated usage from the estimated usages for the sub-sets; and
performing a significance test using the estimated usages for the sub-sets,
wherein determining an estimated usage comprises determining an estimated usage for each of the sub-sets.

13. The method of claim 9, wherein the data is asynchronous.

14. The method of claim 9, wherein determining the estimated usage is performed using a ridge regression.

15. An apparatus operable for carrying out the method of claim 9.

16. A method of estimating usage of a component within an application environment, wherein the method comprises:
separating data regarding workload and utilization of the component into sub-sets;
for each of the sub-sets, determining an estimated usage of the component for a transaction type; and
performing a significance test using the estimated usages for the sub-sets.

17. The method of claim 16, wherein the data is asynchronous.

18. The method of claim 16, wherein determining estimated usages are performed using regression.

19. An apparatus operable for carrying out the method of claim 16.

20. A data processing system readable medium having code for estimating usage of a component within an application environment, wherein the code is embodied within the data processing system readable medium, the code comprising:
an instruction for conditioning data regarding workload and utilization of a component; and
an instruction for determining an estimated usage of the component for a transaction type, wherein the instruction for determining the estimated usage is executed during or after the instruction for conditioning the data.

21. The data processing system readable medium of claim 20, wherein the code further comprises:
an instruction for separating the data into sub-sets;
an instruction for determining an averaged estimated usage from the estimated usages for the sub-sets; and
an instruction for performing a significance test using the estimated usages for the sub-sets,
wherein the instruction for determining an estimated usage comprises an instruction for determining an estimated usage for each of the sub-sets.

22. The data processing system readable medium of claim 20, wherein the instruction for conditioning includes one or more of:
an instruction for smoothing the data;
an instruction for filtering the data; and
an instruction for determining an accuracy for the estimated usage.

23. The data processing system readable medium of claim 20, wherein the data is asynchronous.

24. The data processing system readable medium of claim 20, wherein the instruction for determining the estimated usage comprises an instruction for determining the estimated usage using regression.

25. The data processing system readable medium of claim 20, wherein:
the code further comprises an instruction for collecting the data asynchronously;
the instruction for conditioning comprises:
an instruction for smoothing the data before determining the estimated usage; and
an instruction for filtering the data before executing the instruction for determining the estimated usage;
the instruction for determining the estimated usage is executed using regression; and
the code further comprises an instruction for determining an accuracy for the estimated usage.

26. The data processing system readable medium of claim 25, wherein the code further comprises:
an instruction for separating the data into sub-sets;
an instruction for determining an averaged estimated usage from the estimated usages for the sub-sets; and
an instruction for performing a significance test using the estimated usages for the sub-sets,
wherein the instruction for determining an estimated usage comprises an instruction for determining an estimated usage for each of the sub-sets.

27. A data processing system readable medium having code for estimating usage of a component within an application environment, wherein the code is embodied within the data processing system readable medium, the code comprising:
an instruction for accessing data regarding workload and utilization of the component; and
an instruction for determining an estimated usage of the component for a transaction type, wherein the instruction for determining is executing using a mechanism that is designed to work with a collinear relationship.

28. The data processing system readable medium of claim 27, wherein the code further comprises an instruction for conditioning the data before executing the instruction for determining the estimated usage.

29. The data processing system readable medium of claim 28, wherein the instruction for conditioning includes one or more of:
an instruction for smoothing the data;
an instruction for filtering the data; and
an instruction for determining an accuracy for the estimated usage.

30. The data processing system readable medium of claim 27, wherein the code further comprises:
an instruction for separating the data into sub-sets;
an instruction for determining an averaged estimated usage from the estimated usages for the sub-sets; and
an instruction for performing a significance test using the estimated usages for the sub-sets,
wherein the instruction for determining an estimated usage comprises an instruction for determining an estimated usage for each of the sub-sets.

31. The data processing system readable medium of claim 27, wherein the data is asynchronous.

32. The data processing system readable medium of claim 27, wherein the instruction for determining the estimated usage comprises an instruction for determining the estimated usage using ridge regression.

33. A data processing system readable medium having code for estimating usage of a component within an application environment, wherein the code is embodied within the data processing system readable medium, the code comprising:
an instruction for separating data regarding workload and utilization of the component into sub-sets;
for each of the sub-sets, an instruction for determining an estimated usage of the component for a transaction type; and
an instruction for performing a significance test using the estimated usages for the sub-sets.

34. The data processing system readable medium of claim 33, wherein the data is asynchronous.

35. The data processing system readable medium of claim 33, wherein the instruction for determining estimated usages comprises an instruction for determining estimated usages using regression.
